(19) United States
(12) Patent Application Publication
(10) Pub. No.: US 2016/0102912 A1
(43) Pub. Date: Apr. 14, 2016

(54) METHOD OF DRYING SOLID BIOMASS

(71) Applicant: AGRAOPLAS ASA, Oslo (NO)

(72) Inventors: Runar GUNDERSEN, Bø (NO); Ståle AMUNDSEN, Bø (NO); Bjørn UTGÅRD, Oslo (NO)

(21) Appl. No.: 14/426,311

(22) PCT Filed: Jun. 26, 2013
(86) PCT No.: PCT/EP2013/063366

§ 371 Date: Mar. 5, 2015

(51) Int. Cl. F26B 5/14; B65B 63/02; F26B 17/10

(52) U.S. Cl. CPC F26B 5/14; F26B 17/107; B65B 63/02

(57) ABSTRACT

A method of drying solid biomass is disclosed. Particles of the biomass are first mechanically pre-dried by feeding them into a press. There they are partially split into fibers to increase their surface area, and liquid is squeezed out of them and from between them. The liquid is led away from the press. The mechanically pre-dried biomass particles are immediately fed out of the press into a process gas stream that entrains them and feeds them tangentially into a cyclonic processing chamber. In the chamber, the particles collide with themselves and with other solids that have been introduced into the chamber. The water and steam released by these collisions is led out of the top of the chamber, and the dried particles are led out the bottom.

### CROSS-REFERENCE TO RELATED APPLICATIONS

This application claims priority to PCT/EP2013/063366 filed on Jun. 26, 2013, the contents of which are fully incorporated herein by reference.

### FIELD OF THE INVENTION

The present invention concerns a method of drying solid biomass.

### BACKGROUND OF THE INVENTION

In the production of solid biofuel, e.g. pellets, out of solid biomass thermal drying makes up 70% of the total energy consumption and about 50% of the total production cost, including labor but excluding raw material cost. This has the effect of making solid biofuels prohibitively expensive, hampering the deployment of solid biofuels as a replacement of fossil fuels in heavy industry and stationary energy supply.

### Prior Art

The prior art document DE 20 201 1 102 965 U1 pays attention to the above energy question by acknowledging that thermal drying of solid biomass in the form of wood chips does in fact require great amounts of energy and does negatively influence the total energy balance of wood fuel produced by means of thermal drying. One way to improve the energy balance is to run the wood chips to be dried through a press, in which liquid enclosed inside of and between the wood chips is squeezed out. In these circumstances, according to said prior art document, previous solutions have the drawback that they do not pay attention to the fact that the wood chips as soon as pressure is released tend to reabsorb some of the liquid squeezed out.

According to DE 20 201 1 102 965 U1 that problem is mitigated by designing the press in a way that promotes discharge of squeezed out liquid from the press itself.

### Object of the Invention

The inventors behind the present invention agree to the prior art findings that an optimized press presents an advantageous solution to reduce the moisture content of solid biomass, such as wood chips. However, by compression alone the moisture content can only be reduced to a wet basis moisture content of about 30%, which means that an extra drying step is still required in order to bring the wet basis moisture content down to an incineration friendly level of about 20%.

Against that background the object of the present invention is to improve basically mechanical drying of solid biomass such that a wet basis moisture content of about 20% is possible to reach when starting out from a wet basis moisture content of as much as 75%.

### BRIEF SUMMARY OF THE INVENTION

According to the invention this is achieved by means of a method of drying solid biomass, comprising the steps of feeding biomass particles into a press where the particles by pressing are at least partially split into fibers such that an overall larger particle surface is created and liquid enclosed in and between the particles is squeezed out and led away from the press, thus mechanically predrying the particles, immediately feeding the mechanically predried particles out of the press into a process gas stream entraining and feeding said particles tangentially into a cyclonic processing chamber, where they are driven by said gas stream into a swirling motion, separating liquid remaining on the surface and in a surface layer of the particles from the particles by exposing the particles to said gas stream inside the chamber, making the particles collide with each other, wherein droplets of liquid and vapor thus separated are led out of the processing chamber at a top part thereof and dried particles are led out of the processing chamber at a bottom part thereof.

As indicated before, in the prior art device according to DE 20 201 1102 965 U1 the problem that solid biomass, such as woodchips, compacted in a press does reabsorb squeezed out liquid is clearly identified. However, starting out from a wet basis moisture content of up to 75%, pressing alone cannot bring the wet basis moisture content of solid biomass down to a level really suitable for incineration, that is about 20%, even if most of the liquid squeezed out is actually led away from the press and the biomass therein. Hence a further drying step is obviously required after the squeezing operation. In that respect the document DE 20 201 1 102 965 U1 is mute, but from the introductory part of the document speaking, where thermal drying is mentioned, it is fair to assume that a thermal drying step would be the natural choice for a person skilled in the art having knowledge of said document and facing the task of bringing the wet basis moisture content down further.

The invention as claimed does not rely on such thermal drying but recommends a further substantially mechanical step in time so shortly after the pressing step (within seconds), that the compacted biomass does not find time to reabsorb any substantial amounts of liquid. Said substantially mechanical step comprises separating of liquid remaining on a surface and in a surface layer of the particles from the particles by exposing the particles to said air stream inside the chamber, thus making the particles collide with each other. In that way liquid on the surface and in the surface layer of the particles is freed and caught by said air stream in order to be led out of the chamber. From an energy point of view this substantially mechanical step is far more efficient than a thermal drying step, but does yet result in sufficiently dry particles for incineration.

According to a preferred embodiment for cold conditions the method can comprise a step of preheating the biomass particles to a temperature above the freezing point before they are fed into the press, which makes the press work more efficiently because liquid flow is enabled.

Optionally the method can comprise a step of sizing the biomass particles such that only particles of a size less than 50 mm are fed into the press. Again this makes the press work more efficiently, because oversized particles are difficult to split into fibers.

Preferably, while entraining the predried particles into said processing chamber, the method comprises the additional step of heating said particles to a temperature of 20-55° C., more preferably to 25-50° C., and most preferably to 35-45° C. in order to achieve a constant dryness level of particles led out of the processing chamber. The advantage of heating while entraining the par-tides to the processing chamber is that the area to be heated is rather restricted and hence suitable for infrared or microwave heating, wherein the latter is preferred due to its efficiency.

Preferably the method comprises the additional step of leading at least one extra tangential process gas stream into the processing chamber in order to enhance a cyclonic function thereof. Such an extra gas stream enhances the swirling motion of the particles inside the cyclonic processing chamber, which promotes liquid separation. Further, the extra gas stream renders control of the chamber easier because it comprises of clean gas, i.e. gas not influenced by having to entrain particles.

Optionally the method can comprise the additional step of heating said at least one extra tangential air stream to a temperature of 75-105° C., more preferably to 80-100° C., and most preferably to 85-95° C. Even such moderate heating can contribute substantially to evaporating liquid dispersed inside of the cyclonic processing chamber.

Preferably the method comprises the additional step of immediately packaging the particles when led out of the processing chamber. In contrary to known methods of thermally drying solid biomass, the method according to the invention does not produce hot particles that have to be cooled before packaging. This saves space required for unforced cooling or energy and equipment required for forced cooling.

Preferably the packaging step comprises densifying of the particles. Particles of biomass dried by means of the method according to the invention lend themselves to densification, and once densified they form a fuel product that is transportable at a reasonable cost.

According to one embodiment the step of densifying comprises pelletizing, the resulting pellets being suitable especially for smaller heating sys-terns.

According to another embodiment the step of densifying comprises baling. In this context, by baling is meant densifying and wrapping the particles in plastic foil such that climate safe bales of about 700 kilograms are created. Such bales are especially suitable for larger heating systems, such as district heating devices.

According to a further embodiment the method according to the invention comprises the additional step of intensifying particle collision inside the processing chamber by introducing other solids. By other solids are meant physical objects of any shape and/or design with higher density than the particles fed into the process. The solids can consist of materials such as hard plastic and rubber, steel, ceramics, etc.

### BRIEF DESCRIPTION OF THE SEVERAL VIEWS OF THE DRAWINGS

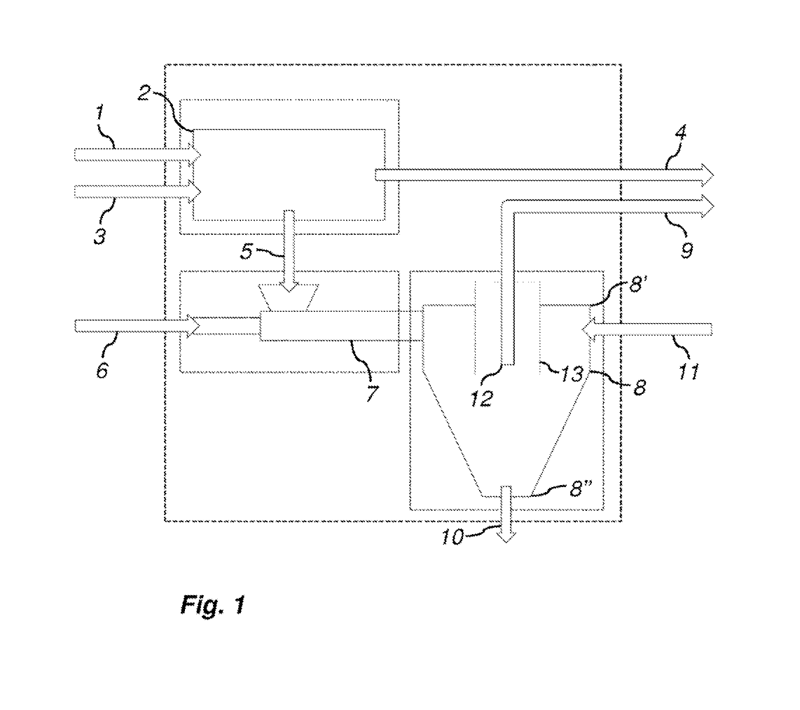

In FIG. 1 a preferred embodiment of the present invention is presented schematically.

### DETAILED DESCRIPTION OF THE INVENTION

The object of the method of drying according to the invention is to dry (dewater) particles of solid biomass to a wet basis moisture content of 20% with significant energy savings compared to prior art involving or based upon thermal drying. A wet basis moisture content on that level is known to lead to an optimized fuel value and to minimized biological degradation (fungal growth).

By solid biomass is meant a raw material from a biomass source, such as forests, plantations and other virgin woods as well as the wood processing industry (by-products and residues). However, other forms of biomass, including herbaceous biomass and biomass blends and mixtures, may be processed too by means of the method according to the invention. In general the wet basis moisture content of solid biomass to be dried by means of the method according to the invention initially ranges from 25 to 75%.

The method according to the invention depends on the solid biomass being provided in the form of particles. When provided as woodchips or hog fuel a maximum particle size of 50 mm presently is preferred, and to reach that goal the method according to the invention can comprise use of some kind of sizing equipment, that allows intake of larger size particles, such as logs and firewood.

According to the invention the dried biomass particles are be further processed into solid biofuel products, such as briquettes, pellets, wood chips (in bulk or bales), sawdust (in bulk or bales), hog fuel (in bulk or bales), or other suitable forms.

In the following a preferred embodiment according to the invention is described in greater detail with reference being had to FIG. 1.

As can be seen the first step of the method according to the preferred embodiment comprises a compression and extraction step. In this step bio-mass, preferably in the form of woodchips, is fed 1 into a press 2 by means of a screw, band or other conveyor. Over-sized particles are removed by conventional means prior to the press 2, because they require pre-processing (sizing) in order to fit the method according to the invention.

In the press 2, such as roller press, a piston press or any other suitable mechanical press known in the art, the particles are exposed to compression forces 3 in a pressure range of up to 35 MPa. The applied forces 3 make the particles due to a sponge like effect release liquid to their surface. There are reports of prior art speaking of a power consumption as low as 275-1290 kJ/kg moisture removed by compressing woodchips.

When the compression step is finished, the individual fibers of the particles will be partially or fully separated from each other, in effect increasing the surface area of the material. Maximum efficiency in the surface moisture removal and drying stage is achieved with maximum separation of individual fibers or clusters of fibers.

After the compression step, a great part of the liquid which before was entrained in pores inside the particles will remain as free liquid on the surface of the particles. Preferably the press 2 is designed to drain 4 at least part of that liquid out of the press, according to prior art by means of gravity and channels or ducts or by some other means, such as suction or blowing. How-ever, a fraction of the freed liquid will remain on the particle surface.

As soon as the compression forces 3 are released, the pores of the particles will tend to expand, creating a suction force which pulls the expelled liquid back into the pores, starting of course at the pores in a surface layer of the particles. The rate of this re-entrainment of liquid is such that the majority of expelled liquid will be re-entrained in the order of seconds or minutes.

The second step of the method according to the preferred embodiment of the invention comprises a transfer step that is to follow the initial compression and extraction step as quickly as possible.

In the second step the particles are immediately and quickly conveyed (transferred) from the outlet of the press to a third step, which is a surface moisture removal and drying step described below. The duration of transfer is preferably a matter of seconds. Minimizing the time of transfer is of key importance for minimizing the liquid re-entrainment effect caused by the expansion of pores in the particles. Better results (i.e. a lower specific energy consumption) will be achieved with shorter transfer times.

The conveying 7 as such is preferably driven pneumatically by means of all or a fraction of a process gas 6 (e.g. air or steam) used in the surface moisture removal and drying step to be described below. In one embodiment, this is achieved by means of a blower combined with an ejector, wherein the particles are fed 5 directly onto the ejector when leaving the press 2. In another embodiment the conveying 7 is driven by a suction force or vacuum created in the subsequent surface moisture removal and drying step.

In a special embodiment of the invention a magnetron device emanating microwaves can be used in order to adjust and homogenize the temperature of the particles while being conveyed. However, other means of thermal energy input can be used as well in the same purpose.

As indicated before, the third step of the method according to the preferred embodiment of the invention is a surface moisture removal and drying step.

In the third step use is made of a cyclonic processing chamber 8, that has a circular cylindrical top part 8′, having a central top outlet 12 sleeved by a tube 13 extending into said top part 8′. Downwards said top part 8′ tapers towards a bottom outlet 8″ aligned with the top outlet 12. According to the invention in a mixture with process gas and particles and liquid enter the top part 8′ of the cyclonic processing chamber 8 along a substantially tangential path in relation to said chamber, such that said mixture is given a swirling motion therein.

Inside the cyclonic processing chamber 8 the particles are dried by a combination of convection drying (phase transfer; evaporative drying) and surface moisture removal (phase separation, wood/liquid).

According to the laws of thermodynamics phase transfer (evaporation) requires a minimum of 3155 kJ per kg moisture (water) removed, whereas phase separation is possible with much lower energy use. Hence maximum efficiency is achieved when phase separation is the predominant mechanism of moisture removal, which speaks for a low transfer time from the press 2 to the cyclonic processing chamber 8. By means of early versions of the method according to the invention a specific energy use of 1400 to 1800 kJ/kg water removed has shown to be achievable when drying woodchips.

Phase separation happens mainly due to inter-particle collisions, but also due to collisions between the particles and chamber walls, shear forces and particle spin. There are various known methods for surface moisture removal, but according to the preferred embodiment of the invention, the cyclonic processing chamber 8, in which the particles are processed, is so called vortex chamber with multiple nozzles (c.f. reference number 11) for tangentially introducing process gas and thus enhancing the swirling motion of the particles inside the chamber 8. Thus, preferably the cyclonic processing chamber 8 is designed to maximize phase separation due to shear forces, particle-particle and particle-wall collisions and particle spin instead of evaporative separation.

Moisture is separated from the particles and entrained in the gas flow 9 exiting the processing chamber 8 through the top outlet 12, whereas the particles dried in said chamber 8 leave it through the bottom outlet 8″.

It goes without saying that multiple, subsequent steps may be combined to enhance the drying capability of the method according to the invention. Out of the same reason the process gas may be heated, thus increasing the convection drying while maintaining the phase separation efficiency.

Preferably the process gas may be at a pressure of 0.1 to 0.8 bar. However, higher pressures may also be employed if deemed necessary. Temperatures in the method according to the invention may be from 30 to 500° C., but preferably temperatures below 140° are used to avoid release of VOC's from the particles.

It is possible to involve other methods of drying, which in-part or completely rely on phase separation, such as flash dryers.

Thanks to the method according to the invention energy efficiency of both the compression step and the surface moisture removal and drying step is improved. Further, reabsorption of moisture after release of compression is reduced because the moisture is quickly removed from particle surfaces. This increases the energy efficiency of the compression step. The energy efficiency of the subsequent drying step is improved too. The drying step efficiency is improved due to the increase of surface area and the increase of freely available surface moisture (as opposed to reabsorbed) compared to what would be the case if the particles were not compressed first.

It is known in the prior art that compression as described above can increase the efficiency of thermal drying. However, the method according to the invention forms an improvement over prior art by (a) optimizing the interface and transfer step (minimizing time delay, immediately starting phase separation) and (b) by utilizing a drying process which enables surface moisture removal in addition to convection drying.

From the prior art it is known that the energy efficiency improvement of a combined compression and thermal drying over thermal drying alone is amounts to about 50% when dewatering to 20% moisture. While thermal drying theoretically is bound to consume at least 3155 kJ/kg moisture removed, the combined method (compression and thermal drying) consumes around 1600 kJ/kg moisture removed. By replacing the thermal drying step with a vortex drying process step as described above, further reduction of energy consumption in the order of 30 to 50% can be achieved compared to the combined known system described above.

The synergic benefits are likely to enable a further reduction of energy consumption by reducing the energy consumption of both the compression step (estimated 20% reduction) and the surface moisture and dewatering step (estimated 50% reduction), creating a method able to achieve a total reduction of more than 70% compared with the combined method described in the prior art above and more than 80% compared to thermal drying alone.

The emission of VOC's is improved over the prior art described above due to the deployment of drying technology operated at temperatures below 140° C. The fact that drying at lower temperatures reduces VOC emissions is known in the prior art, but the combination with lower energy consumption due to the system integration described above is not known.

In commercial deployments, the disclosed integrated biomass dewatering method can be combined with other processing equipment into complete engineered solid biofuel manufacturing systems.

Thus the shaft power used to energize the method according to the invention may be generated using a heat engine or turbine, such as a steam engine, sterling engine, ORC turbine, etc. This makes it possible to partially or completely replace the electric energy consumption for energizing the method, using instead low-temperature waste heat as the energy source.

The gas driving the surface moisture removal and drying step may be preheated, prior to compression, by using waste heat from industrial processes. This will increase the convection drying achieved in the drying step.

The dewatered biomass may be compacted by using a compaction machine, such as a pelletizer or baler. Due to the splitting of fibers and clusters of fibers achieved by means of the integrated biomass dewatering method, the compaction efficiency is improved due to better cross-linking than would be achieved with uncompressed woodchips.

What is claimed:

1. A Method of drying solid biomass, comprising the steps of:
providing a press, a process gas stream and a cyclonic processing chamber;
mechanically pre-drying said biomass, comprising:
feeding biomass particles into said press;
pressing said biomass particle in said press, thereby:
partially splitting said biomass particles into fibers thereby increasing their surface area; and
squeezing out liquid enclosed in and between said biomass particles;
leading said squeezed out liquid away from said press;
feeding, immediately after mechanically pre-drying, said mechanically pre-dried particles out of said press into said process gas stream;
entraining, by said process gas stream; said mechanically pre-dried particles;
feeding, by said process gas stream, said entrained, mechanically pre-dried particles tangentially into said cyclonic processing chamber thereby driving them into a swirling motion;
separating liquid remaining on the surface and reabsorbed in a surface layer of the mechanically pre-dried particles by making them collide with each other by exposing them to said process gas stream inside the chamber;
intensifying said collisions of said mechanically pre-dried particle by having them collide with other solids introduced into the processing chamber; and
leading said separated droplets of liquid and vapor out of a top part of said processing chamber, and said dried biomass particles out of a bottom part thereof.

2. The method according to claim 1, wherein immediately feeding the mechanically pre-dried particles out of said press into said process gas stream takes a maximum of 60 seconds.

3. The method of claim 1 further including preheating the biomass particles to a temperature above the freezing point of water before they are fed into said press.

4. The method of claim 1 further comprising sizing the biomass particles such that only particles of a size less than 50 mm are fed into said press.

5. The method of claim 1 further comprising heating said particles to a temperature of 20-55° C., while entraining the pre-dried particles into said processing chamber.

6. The method of claim 1 further comprising leading at least one extra tangential process gas stream into the processing chamber.

7. The method of claim 6 further comprising heating said at least one extra gas stream to a temperature of 75-105 ° C.

8. The method of claim 1 further comprising immediately packaging the particles when led out of the processing chamber.

9. The method of claim 8, wherein the packaging step comprises densifying of the particles.

10. The method of claim 9 wherein the step of densifying comprises pelletizing.

11. The method of claim 9 wherein the step of densifying comprises baling.
